(19) United States
(12) Patent Application Publication
(10) Pub. No.: US 2011/0144908 A1
(43) Pub. Date: Jun. 16, 2011

(54) Method of locating nearby low priced items using a personal navigation device

(76) Inventor: Dorothy Cheong, North Shore City (NZ)

(21) Appl. No.: 12/635,684

(22) Filed: Dec. 10, 2009

(51) Int. Cl. G06F 17/30; G06Q 30/00; G01C 21/36; G06F 3/048

(52) U.S. Cl. 701/209; 707/769; 707/723; 701/300; 715/764; 707/E17.014; 707/E17.017; 705/26.8

(57) ABSTRACT

A method of locating nearby low priced items by utilizing a personal navigation device includes entering a shopping list of items a user wishes to buy through a user interface of the personal navigation device, the personal navigation device searching for each item on the shopping list in a database containing product price data and corresponding location data of stores selling one or more items on the shopping list, and the personal navigation device displaying search results for items on the shopping list that are found in the database, the search results including the price of the items and locations at which corresponding stores are located.

### BACKGROUND OF THE INVENTION

1. Field of the Invention

The invention relates to a location based shopping assisting method, and more particularly, to a method and related device for utilizing a personal navigation device and a product database for locating low priced items for sale at stores located within the vicinity of the personal navigation device.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Personal GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

Conventionally, personal navigation devices are not able to assist users in locating items that are on sale. If a user wishes to buy a certain item, the user can utilize the personal navigation device to help the user navigate to a store that is known to sell that item. Otherwise, the personal navigation device may be able to offer suggestions of stores to the user based on a store category, such as “electronics store”. While the user is able to navigate to the store using the personal navigation device, the user cannot get any indication from the personal navigation device about the price of the item or items that the user wishes to buy. The user is instead left on his own to search on the internet or through printed advertisements for located items that are on sale. Once a store is found, the user can then input the store's address into the personal navigation device in order to receive instructions on how to get to the store.

Unfortunately, the prior art method for searching for items on sale and then traveling to the corresponding store is time consuming and inconvenient. It forces the user to search for product and price information at home or in the office, write down the address of the store where the product is sold, enter the address into the personal navigation device, and then travel to the store. What's more, when looking up product information, the user often has no clear idea of how far away the store is from the user's current location based on the store's address. This may cause the user to select a store that is farther away than other stores that carry the same item at the same or a similar price. To make matters worse, when a user has a shopping list containing multiple items, the job of searching for and buying items becomes even more burdensome.

### SUMMARY OF THE INVENTION

It is therefore one of the primary objectives of the claimed invention to provide a method and related device of utilizing a personal navigation device to search for low priced items, present the user with a list of nearby stores and corresponding sale prices, and guiding the user to a selected store.

According to an exemplary embodiment of the claimed invention, a method of locating nearby low priced items by utilizing a personal navigation device is disclosed. The method includes entering a shopping list of items a user wishes to buy through a user interface of the personal navigation device, the personal navigation device searching for each item on the shopping list in a database containing product price data and corresponding location data of stores selling one or more items on the shopping list, and the personal navigation device displaying search results for items on the shopping list that are found in the database, the search results including the price of the items and locations at which corresponding stores are located.

According to another exemplary embodiment of the claimed invention, a personal navigation device for locating nearby low priced items is disclosed. The personal navigation device includes a memory for storing a shopping list of items a user wishes to buy, a processor for controlling operation of the personal navigation device and for searching for each item on the shopping list in a database containing product price data and corresponding location data of stores selling one or more items on the shopping list, and a display for displaying search results for items on the shopping list that are found in the database, the search results including the price of the items and locations at which corresponding stores are located.

It is an advantage that the present invention allows the user to utilize the personal navigation device for both searching for the items on sale as well as for providing instructions on how to get to a selected store. The present invention simplifies the task of buying items on sale, and also continuously searches for items according to newly updated prices as well as the current position of the personal navigation device as the user travels. Therefore, the user has many more chances to buy items at desired prices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a personal navigation device in communication with a server according to the present invention.

FIG. 2 is a flowchart illustrating the present invention method of utilizing the personal navigation device for assisting in locating low priced items at nearby stores.

FIG. 3 is an example screen shot showing search results overlaid on a map of an area surrounding the current location of the personal navigation device.

FIG. 4 is a table showing search results sorted according to price.

### DETAILED DESCRIPTION

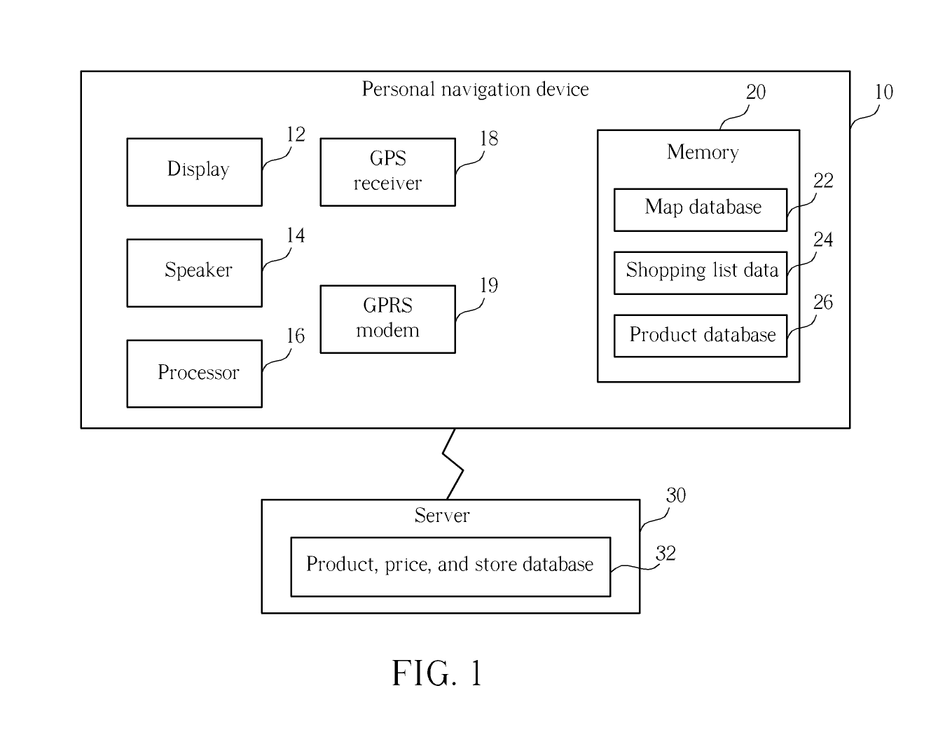

Please refer to FIG. 1. FIG. 1 is a functional block diagram showing a personal navigation device 10 in communication with a server 30 according to the present invention. The personal navigation device 10 has a user interface containing such devices as a display 12 and a speaker 14. The display 12 can be a touch-sensitive display for allowing a user of the personal navigation device 10 to input commands and data using the display 12. The personal navigation device 10 also contains a processor 16 for controlling operation of the personal navigation device 10. A GPS receiver 18 is used for receiving position information indicating the current position of the personal navigation device 10.

The personal navigation device 10 also contains a General Packet Radio Service (GPRS) modem 19 for allowing wireless communication and for providing internet access. Other wireless communication standards can also be used instead of the GPRS modem 19, such as a wireless local area network (WLAN) transceiver.

The personal navigation device 10 comprises a memory 20 containing a map database 22 for storing map data, address data, POI data, etc. The memory 20 also stores shopping list data 24 for recording items that a user wishes to buy. The memory 20 may also optionally store a product database 26 in memory, although this is not required.

The server 30 can be accessed through the internet, and contains a database 32 containing product, price, and store information. The database 32 can be a custom database made by the manufacturers of the personal navigation device 10, or can be an existing database such as one of the many internet websites that provides price comparison information taken from various online and brick and mortar stores. As will be explained in greater detail below, the user of the personal navigation device 10 enters a shopping list of items into the personal navigation device 10, which is stored in the shopping list data 24 section of memory 20. The personal navigation device 10 then communicates with the server 30 for determining the best prices for items on the shopping list as well as the locations of the corresponding stores that sell the items.

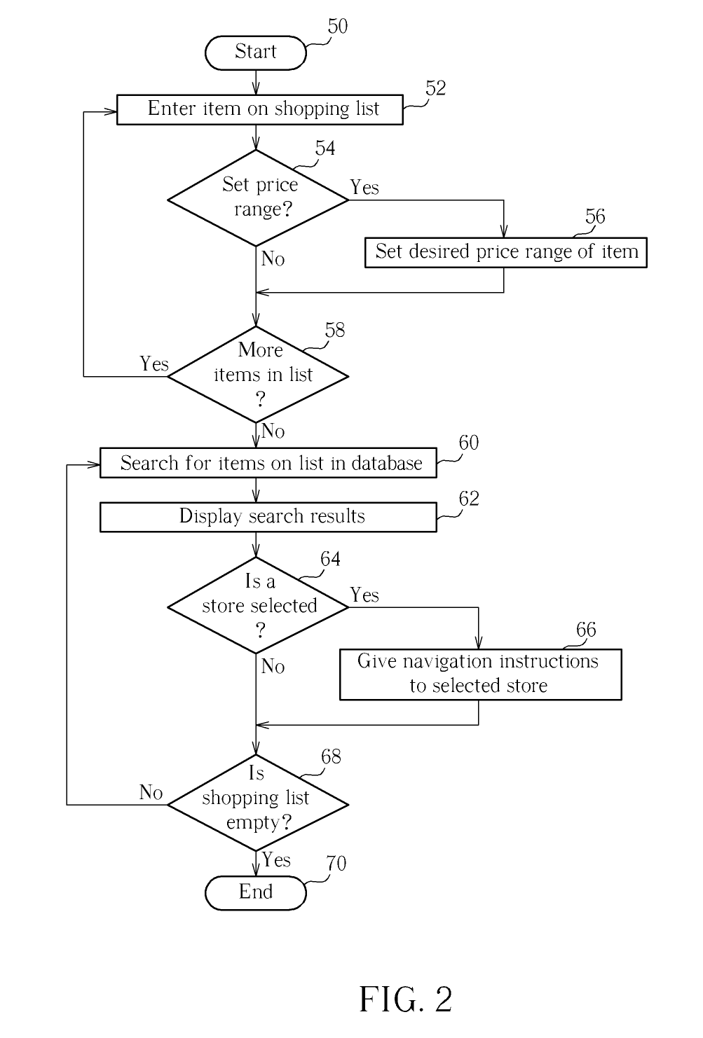

Please refer to FIG. 2. FIG. 2 is a flowchart illustrating the present invention method of utilizing the personal navigation device 10 for assisting in locating low priced items at nearby stores. Steps contained in the flowchart will be explained below.

Step 50: Start.

Step 52: The user enters an item on the user's shopping list into the personal navigation device 10, and this item is stored in the shopping list data 24 section of memory 20.

Step 54: The personal navigation device 10 prompts the user to optionally enter a desired price range for purchasing this item. If the user wishes to enter a price range, go to step 56. If not, go to step 58.

Step 56: The user enters a price range for the item. The user may set both a minimum and a maximum price, or set only a maximum price.

Step 58: Determine if the user has more items on the shopping list to enter into the personal navigation device 10. If so, go back to step 52. If not, go to step 60.

Step 60: Search for items on the shopping list. The searching can be performed locally in the product database 26 stored in the memory 20 of the personal navigation device 10, or is preferably performed by the server 30 using the database 32 stored in the server 30. If a price range was entered for each item, this price range is used to refine the search results.

Step 62: The search results are displayed on the display 12 of the personal navigation device 10. These results can be shown immediately after the user has entered the shopping list, or can be shown later on after the personal navigation device 10 has moved closer to the location of stores where items on the shopping list are sold. For simplicity and clarity, results for each item on the list are shown separately. The search results include the price of the item and the location of the store where the item is sold. Optionally, the store name, the distance to the store, and/or the estimated travel time to the store can be shown as well. As will be explained below, the results can be shown as overlaid points on a map, or can be shown in table form.

Step 64: Determine if the user has selected a store from the search results. If so, go to step 66. If not, go to step 68.

Step 66: The personal navigation device 10 provides navigation instructions to the selected store.

Step 68: Determine if the shopping list is empty. That is, determine if all items on the shopping list have now been bought. If so, the process ends at step 70. If not, go back to step 60 so searching can continue.

Step 70: End.

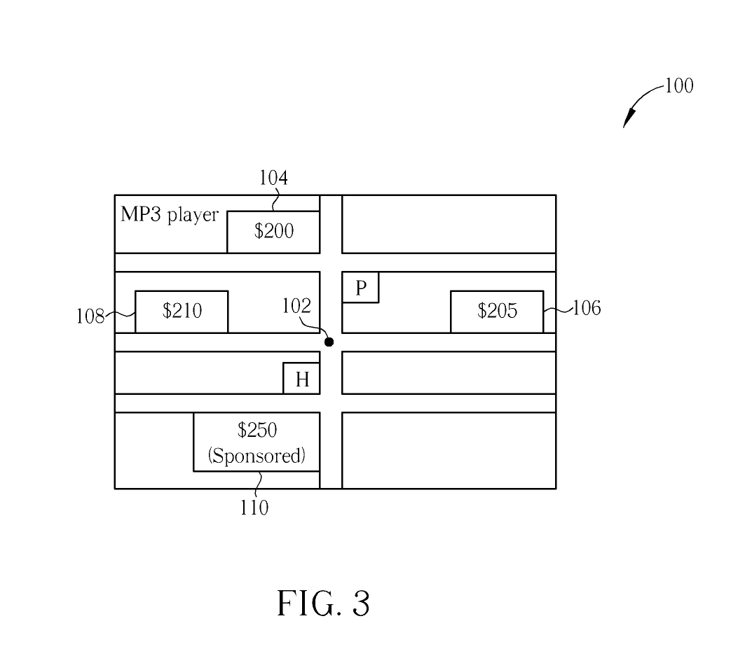

Please refer to FIG. 3. FIG. 3 is an example screen shot 100 showing search results overlaid on a map of an area surrounding the current location 102 of the personal navigation device 10. The search results in FIG. 3 correspond to a specific model of an MP3 player that is on the user's shopping list. Four different search results 104, 106, 108, and 110 are shown, with one search result 110 being a sponsored search result paid for by an advertiser. The sponsored search result 110 is optional, and in this case displays a higher price than that of the other three search results 104, 106, and 108. The map displays not only the prices of the search results 104, 106, 108, and 110, but also the location of the stores where the items are sold relative to the current location 102 of the personal navigation device 10. The names of the stores may also be shown on the map if space permits. If a user wishes to travel to one of the stores shown in the search results 104, 106, 108, and 110, the user can select touch the screen at the position where the search result is displayed to select that store. The personal navigation device 10 will then provide navigation instructions to guide the user to the selected store.

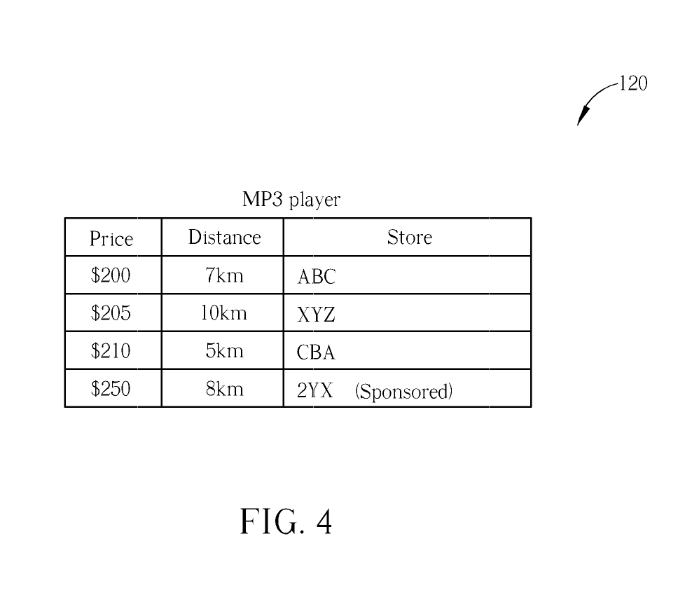

Please refer to FIG. 4. FIG. 4 is a table 120 showing search results sorted according to price. The same search results shown in FIG. 3 are shown in FIG. 4, but are instead shown in table form. The table 120 is preferably sorted by price from lowest price to highest price and then is sorted by distance from nearest distance to farthest distance. Of course, the search results can also be sorted by distance and then by price instead. Also displayed in the table 120 is the name of the store, and the table 120 may also indicate an estimated travel time to the store. The user can click on one row of the table 120 in order to select a store, and the personal navigation device 10 will then provide navigation instructions to guide the user to the selected store.

Items on the shopping list can be continuously searched for, and the database 32 stored on the server 30 or the product database 26 stored in the memory 20 of the personal navigation device 10 can be updated at regular intervals, such as every 3 days, to provide updated results. In addition, since the personal navigation device 10 is a mobile device that can constantly be traveling to different places, the search results should be updated as the personal navigation device 10 changes locations. For example, if the user is commuting home from work, or is traveling on a long road trip, the user may come close to a store that is having a sale on an item in the user's shopping list. In one embodiment, if a distance between the personal navigation device 10 and the store is less than a predetermined threshold distance, the personal navigation device 10 will then inform the user about this sale, and the user can receive navigation instructions to the store. The personal navigation 10 device can inform the user through an audible or visual alert such as an alarm or flashing lights. Thus, the present invention offers more chances for the user to buy items at reduced prices by constantly searching for items according to both price and the current location of the personal navigation device 10.

In summary, the present invention provides the user with a quick and convenient way to comparison shop just by using the personal navigation device 10. Not only does the personal navigation device 10 search for items on sale, but it also provides instructions on how to get to a selected store.

Those skilled in the art will readily observe that numerous modifications and alterations of the device and method may be made while retaining the teachings of the invention.

What is claimed is:

1. A method of locating nearby low priced items by utilizing a personal navigation device, the method comprising:
entering a shopping list of items a user wishes to buy through a user interface of the personal navigation device;
the personal navigation device searching for each item on the shopping list in a database containing product price data and corresponding location data of stores selling one or more items on the shopping list; and
the personal navigation device displaying search results for items on the shopping list that are found in the database, the search results including the price of the items and locations at which corresponding stores are located.

2. The method of claim 1, wherein entering the shopping list of items the user wishes to buy comprises the user indicating a desired price range for one or more items on the shopping list, the desired price range being used for refining search results when searching the database.

3. The method of claim 1, wherein the database is stored in the personal navigation device.

4. The method of claim 1, wherein the database is stored in a server that the personal navigation device communicates with through an internet connection.

5. The method of claim 1, wherein displaying search results comprises sorting results for each item by price from lowest price to highest price and then sorting by distance from a current location of the personal navigation device to the corresponding store from nearest distance to farthest distance.

6. The method of claim 1, wherein displaying search results comprises overlaying search results on a map of an area surrounding a current location of the personal navigation device, and stores selling items on the shopping list are displayed on the map according to their actual location.

7. The method of claim 1 further comprising alerting the user with a visual or audible alert when a distance between a current location of the personal navigation device and a store having a sale on one or more items on the shopping list is less than a predetermined threshold distance.

8. The method of claim 1 further comprising:
the user selecting a store from the displayed search results; and
the personal navigation device providing navigation instructions from a current location of the personal navigation device to the selected store.

9. The method of claim 1 further comprising re-searching for each item on the shopping list and displaying updated search results as the personal navigation device changes locations.

10. The method of claim 1, wherein the database is updated periodically with new product price data and corresponding location data of stores selling one or more items on the shopping list.

11. A personal navigation device for locating nearby low priced items, the personal navigation device comprising:
a memory for storing a shopping list of items a user wishes to buy;
a processor for controlling operation of the personal navigation device and for searching for each item on the shopping list in a database containing product price data and corresponding location data of stores selling one or more items on the shopping list; and
a display for displaying search results for items on the shopping list that are found in the database, the search results including the price of the items and locations at which corresponding stores are located.

12. The personal navigation device of claim 11, wherein the shopping list of items the user wishes to buy comprises a desired price range for one or more items on the shopping list, the desired price range being used for refining search results when searching the database.

13. The personal navigation device of claim 11, wherein the database is stored in the memory of the personal navigation device.

14. The personal navigation device of claim 11, further comprising:
an internet connection module for enabling the personal navigation device to access the internet, wherein the database is stored in a server that the personal navigation device communicates with through the internet connection module.

15. The personal navigation device of claim 11, wherein displayed search results are sorted for each item by price from lowest price to highest price and then sorting by distance from a current location of the personal navigation device to the corresponding store from nearest distance to farthest distance.

16. The personal navigation device of claim 11, wherein displayed search results are overlaid on a map of an area surrounding a current location of the personal navigation device, and stores selling items on the shopping list are displayed on the map according to their actual location.

17. The personal navigation device of claim 11, wherein the processor controls the personal navigation device to alert the user with a visual or audible alert when a distance between a current location of the personal navigation device and a store having a sale on one or more items on the shopping list is less than a predetermined threshold distance.

18. The personal navigation device of claim 11, wherein the user selects a store from the displayed search results, and the personal navigation device provides navigation instructions from a current location of the personal navigation device to the selected store.

19. The personal navigation device of claim 11, wherein the personal navigation device re-searches for each item on the shopping list and displays updated search results as the personal navigation device changes locations.

20. The personal navigation device of claim 11, wherein the database is updated periodically with new product price data and corresponding location data of stores selling one or more items on the shopping list.
